(19) United States
(12) Patent Application Publication
(10) Pub. No.: US 2010/0061818 A1
(43) Pub. Date: Mar. 11, 2010

(54) DIAMETER ADJUSTMENT ORIENTED BALANCING SYSTEM

(75) Inventors: Klaus Lohner, Rochester, NY (US); Thomas Tando, East Rochester, NY (US)

Correspondence Address: HARRIS BEACH PLLC, 99 GARNSEY ROAD, PITTSFORD, NY, 14534, US

(73) Assignee: Parlec, Inc., Fairport, NY (US)

(21) Appl. No.: 12/205,500

(22) Filed: Sep. 5, 2008

(51) Int. Cl. B23B 47/00

(52) U.S. Cl. 408/143

(57) ABSTRACT

A diameter adjustment oriented balancing system is disclosed for use with small diameter rotary boring heads. The diameter adjustment oriented balancing system includes a rotary boring head with a radially movable tool carrier. The rotary boring head designed to receive a number of removable counterweights in one or more slots precisely aligned in the axis of radial movement of the tool carrier. The diameter adjustment oriented balancing system further comprises a series of boring bars which are designed to be perfectly balanced such that the combination of the rotary boring head and cutting tool holder is perfectly balanced when the center of the cutting tool holder is located at the center of the rotational axis of the rotary boring head.

### FIELD OF THE INVENTION

The present invention relates generally to rotary boring heads and, in particular, to a system for counterbalancing unbalances in a rotary boring head. More specifically, the invention relates to a simple and precise system for counterbalancing the unbalances created by the tool carrier and cutting edge holder in a rotary boring head under radial displacement for diameter adjustment. The present invention also relates to a tool carrier and rotary boring head designed to employ the counterbalancing system.

### BACKGROUND OF THE INVENTION

Rotary boring head systems are subjected to unbalances created by uneven rotor mass distribution, radial adjustment of the tool carrier as well as by the cutting edge holder attached. In the interest of making full use of modern cutting tools, the rotary boring heads must run at elevated rotational speeds. This is especially true with regard to small diameter rotary boring heads. The balancing quality of a boring head therefore has a critical influence on spindle performance, machining quality and surface finish. State of the art balancing is done by means of a balancing machine and expensive balancing rings. As such, there is a need to provide a simple and cost effective system for balancing a rotary boring head which allows for a precise balancing of radial unbalances while avoiding lateral unbalances.

### SUMMARY OF THE INVENTION

The present invention provides a diameter adjustment oriented balancing system for small diameter rotary boring heads. The balancing system includes a rotary boring head. The rotary boring head is manufactured to eliminate all lateral unbalances by design.

The rotary boring head includes a rotating body and a spindle adapter. The rotary boring head includes a radially movable tool carrier designed to accommodate a tool holder. The tool carrier includes a precision spindle, which is equipped with a micrometer dial to determine the relative radial adjustment of the tool carrier.

The rotating body further includes one or more slots aligned in the axis of radial motion of the tool carrier designed to accommodate a number of selectively removable counterweights. The counterweights may be set screws, pins, bolts, rivets, weights, inserts, or any other shape known in the art. The counterweights are located on the backside of the rotating body such that the counterweights are secured when the spindle adapter is located in a bit holder or chuck. As such, the counterweights are prevented from separating from the rotating body by centrifugal force while the rotary boring head is in operation.

The counterweights may be selectively added or removed to accommodate for unbalances resulting from radial adjustment of the tool carrier and tool cutting holder. The number of counterweights added or removed is based on the amount of radial adjustment, the diameter of the cutting tool holder and the weight of the cutting tool holder. A chart may be created which outlines the number of counterweights to be selectively added or removed based on the above factors.

The balancing system of the present invention further comprises a number of mass balanced tool cutting tool holders. Each cutting tool holder consists of a nose, a shaft and a counterweight. A cutting insert may be removably attached to the nose of the cutting tool holder. The counterweight, which comprises an additional mass on the rear portion of the nose opposite the cutting insert, is designed to perfectly mass balance the cutting tool holder in all directions. The counterweight may alternatively be machined onto the nose of the cutting tool holder, casted onto the nose of the cutting tool holder, or formed using powder metal technology.

The present invention further provides a method of balancing a small diameter rotary boring head. The method comprises selecting a mass balanced cutting tool holder, placing the cutting tool holder in a radially movable tool carrier in the rotary boring head, radially adjusting the tool carrier to achieve a specific boring diameter, and selectively adding or removing counterweights to balance the rotary boring head based on the cutting tool holder selected and the amount of radial adjustment.

### BRIEF DESCRIPTION OF THE DRAWINGS

The foregoing and other objects, features, and advantages of the invention will be apparent from the following more particular description of the embodiments of the invention.

FIG. 1 depicts a side view of a small diameter rotary boring head in accordance with the present invention wherein the tool carrier is located at a zero position where the rotary boring head is perfectly balanced when a mass balanced tool holder is inserted.

FIG. 2 depicts a side view of the rotary boring head in accordance with the present invention wherein the tool carrier has been adjusted radially.

FIG. 3 depicts a cutting tool holder in accordance with the counterbalancing system of the present invention.

FIG. 4 is a schematic view of the cutting tool holder in accordance with the counterbalancing system of the present invention.

FIG. 5 depicts a schematic top view of the rotary boring head with the cutting tool holder inserted into the cylindrical transverse opening in the rotating body wherein the cutting tool holder is centered on the rotational axis of the rotary boring head.

FIG. 6 depicts a schematic top view of the rotary boring head with the cutting tool holder inserted into the cylindrical transverse opening in the rotating body wherein the tool carrier has been radially adjusted.

FIG. 7 depicts a preferred embodiment of the rotary boring head of the present invention.

### DETAILED DESCRIPTION OF THE INVENTION

The present invention is a system for counterbalancing unbalances in a rotary boring head. In particular, the present invention provides a simple and precise system for counterbalancing unbalances resulting from radial displacement of a tool carrier and a cutting edge holder within the rotary boring head.

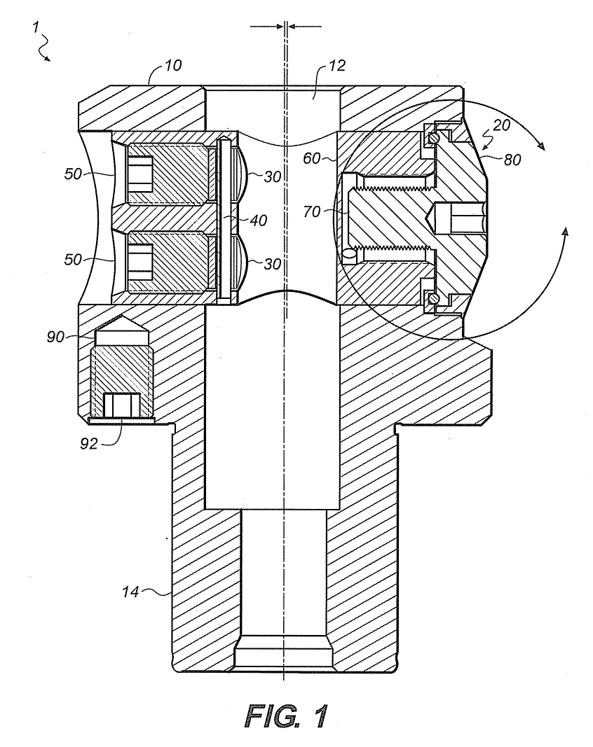

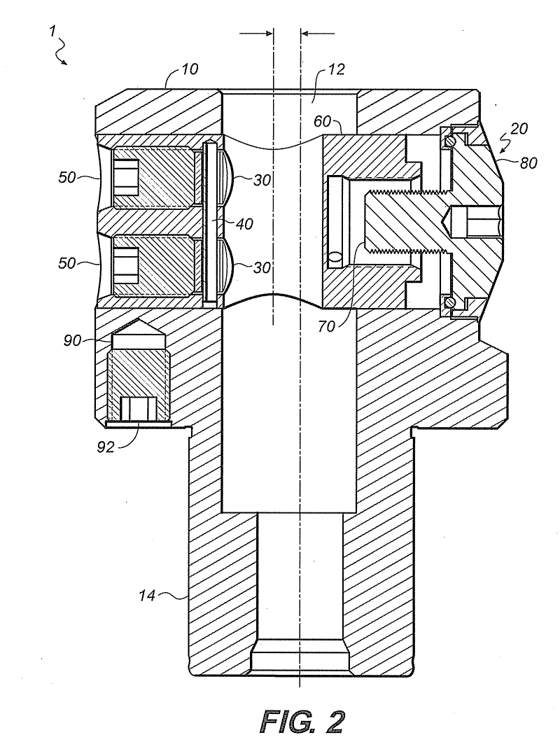

FIGS. 1 and 2 depict side views of a small diameter rotary boring head 1, which is adapted to utilize the counterbalancing system of the present invention. Rotary boring head 1 has a cylindrical rotating body 10 with a cylindrical transverse opening 12 along the longitudinal axis for receiving a cutting edge holder (not shown), such as a boring bar. The rotary boring head 1 further consists of a spindle adapter 14, which allows the rotary boring head 1 to be removably attached to a bit holder or a chuck.

The rotating body 10 further comprises a radially arranged tool carrier 20. The tool carrier 20 is adapted to receive a cutting edge holder. The cutting edge holder is engaged within the tool carrier 20 by tool clamp pads 30. The tool clamp pads 30 have a cylindrical opening along their longitudinal axis, which is adapted to receive a spring pin 40. Set screws 50 are utilized to secure the cutting edge holder within the tool carrier 20.

The tool carrier 20 also comprises a precision nut 60 and a precision spindle 70, which allow for radial adjustment of the position of the cutting edge holder engaged within the tool carrier 20 relative to the rotating body 10. The rotary boring head 1 is pre-balanced during the manufacturing process such that all unbalances lateral to the radial adjustment direction of the tool carrier 20 are eliminated by design.

The precision spindle 70 is equipped with a micrometer dial 80 that allows for relative radial adjustment of the position of the cutting tool holder to change the effective cutting diameter of a cutting tool (not shown), which is either removably attached to, or machined as a part of, the cutting tool holder. FIG. 1 depicts a side view of the rotary boring head 1 in accordance with the present invention wherein the tool carrier 20 is located at a zero position where the rotary boring head 1 is perfectly balanced when a mass balanced tool holder is inserted. FIG. 2 depicts a side view of the rotary boring head 1 in accordance with the present invention wherein the tool carrier 20 has been adjusted radially.

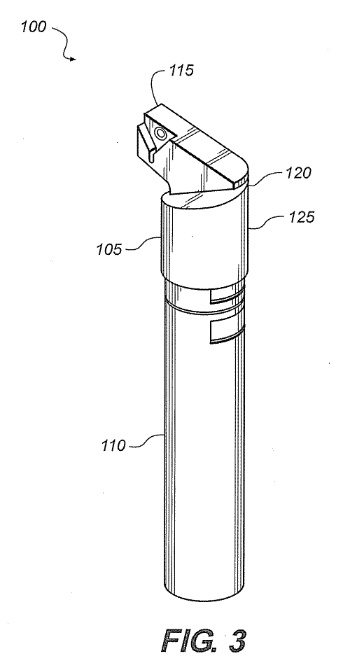

FIG. 3 depicts a cutting tool holder 100, which is adapted for use with the rotary boring head 1 shown in FIGS. 1 and 2 in accordance with the counterbalancing system of the present invention. The cutting tool holder 100 consists of a nose 105, which is removably attached to a shaft 110. The shaft 110 may vary in length and diameter, depending on the cutting application. The shaft 110 may be made of carbide, steel, or any other material used in the art.

The nose 105 is adapted to receive a cutting tool 115, which may be removably attached to the nose 105. The nose 105 further comprises a recessed portion 120, which allows for chip clearance while the cutting tool 115 is in operation. The nose 105 may have different diameters and is coupled to a shaft 110 of the same diameter.

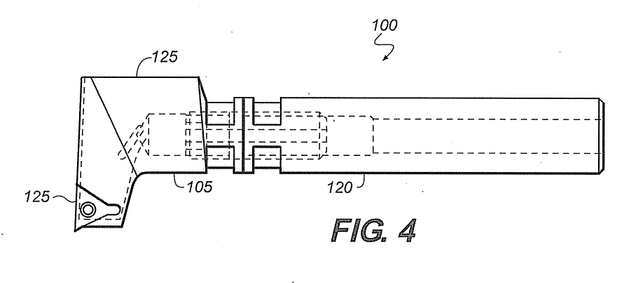

FIG. 4 is a schematic view of the cutting tool holder 100 shown in FIG. 3. The rear portion of the nose 105 includes a counterbalance 125. The counterbalance 125 constitutes an overhang that adds mass to the rear portion of the nose 105. The counterbalance 125 is designed to offset the unbalance created by the recessed portion 120 of the nose 105. The counterbalance 125 may be machined to the correct size and form to obtain a perfectly mass balanced cutting tool holder 100. Alternatively, the correct size and form of the counterbalance 125 may be obtained by casting or powder metal technology. In the preferred embodiment, the counterbalancing system of the present invention includes a series of mass balanced cutting tool holders 100, which vary in length, diameter and material, and may be used for a variety of boring applications. Each cutting tool holder 100 is designed to be perfectly mass balanced in accordance with the above description.

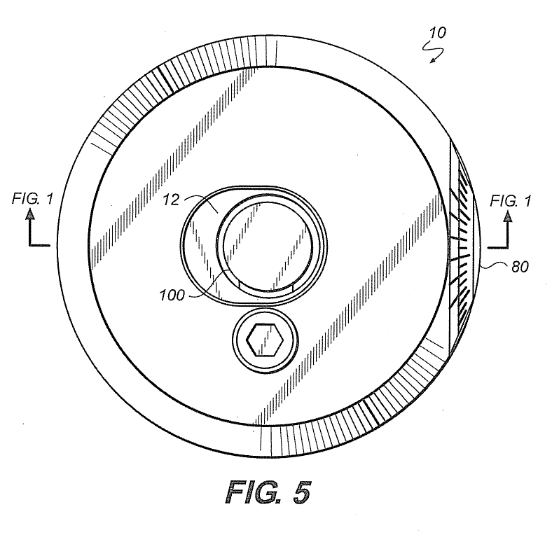

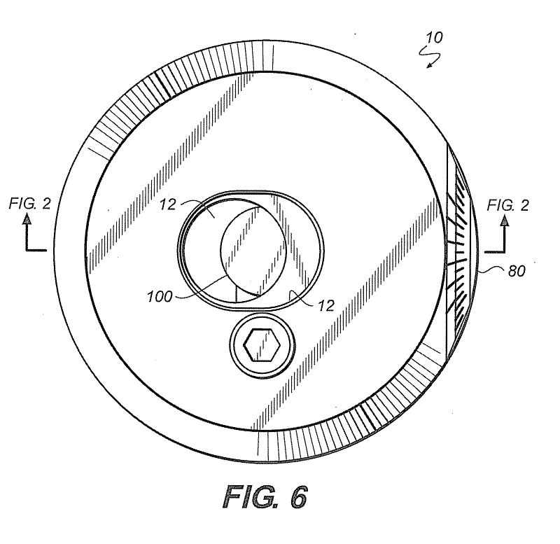

FIGS. 5 and 6 depict schematic top views of the rotary boring head 1 with a cutting tool holder 100 inserted into the cylindrical transverse opening 12 in the rotating body 10. The center of the cutting tool holder 100 may be located at the center of the rotational axis of the rotary boring head 1 as is shown in FIG. 3. The rotating boring head 1 and the cutting tool holder 100 are perfectly balanced when the cutting tool holder 100 is located at the position shown in FIG. 5. The system may be balanced using traditional methods.

Once the rotary boring head 1 and the cutting tool holder 100 are perfectly balanced, radial adjustments may be made to the position of the cutting tool holder 100 by rotating the micrometer dial 80 to increase the diameter of the bore. FIG. 6 depicts a schematic top view wherein the cutting tool holder 100 has been adjusted along the radial axis. The precision spindle 70 forces the precision nut 60 to move, resulting in a radial adjustment of the tool carrier 20 and any cutting tool holder 100 inserted in the tool carrier 20. The micrometer dial 80 allows for precise radial adjustments relative to the pre-set balanced position.

Referring again to FIGS. 1 and 2, one or more slots 90 are located on the bottom portion of the rotating body 10 of the rotary boring head 1. The slots are precisely aligned in the axis of radial movement of the tool carrier 20. The slots are designed to accommodate a number of counterweights 92 with known weight values, which may be removably placed in the slots 90. The slots 90 are located such that the counterweights 92 are not accessible when the rotary boring head 1 is placed in a bit holder or a chuck. As such, the centrifugal forces created by the rotating body 10 do not affect the counterweights 92. The counterweights 92 must be distributed within the slots 90 such that the counterweights 92 do not create any lateral unbalances. The counterweights 92 may be set screws, pins, bolts, rivets or any other shape known in the art.

The rotary boring head 1 may be balanced using traditional methods known in the art with the total number of counterweights 92 located in each of the slots 90. Referring again to FIG. 6, as cutting tool holder 100 is radially adjusted, additional mass is shifted along the radial axis creating unbalances in that direction. Referring again to FIG. 2, a number of the counterweights 92 may be removed to compensate for the additional mass shifted along the radial axis. The number of counterweights 92 which must removed may be calculated based on the characteristics of the cutting tool holder (not shown), such as mass and diameter, and the amount of the radial adjustment. As the amount of the radial adjustment increases, more counterweights 92 may be removed to compensate for the resultant unbalance. A chart may be developed, based upon the characteristics of each particular cutting tool holder employed and the specific amount of relative radial adjustment, which instructs a user of the balancing system on the number of counterweights 92 that must be removed to balance the rotary boring head 1.

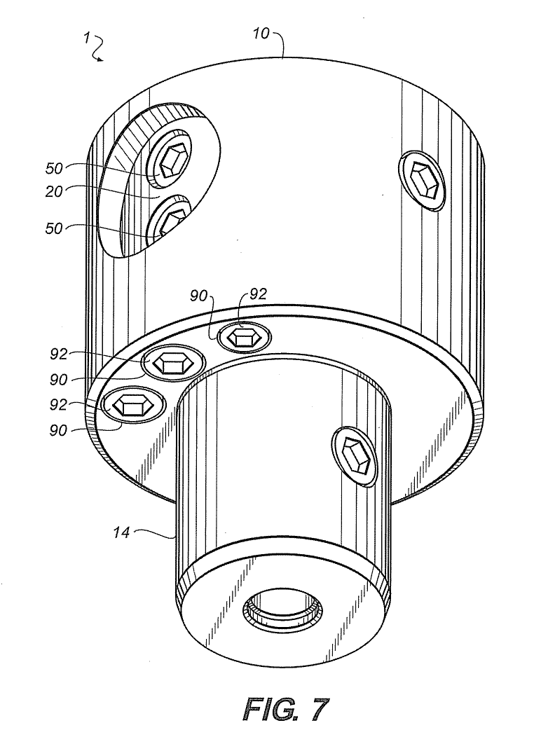

FIG. 7 shows a preferred embodiment of the rotary boring head 1 in accordance with the present invention. Three slots 90 are adapted to receive counterweights 92 in the form of set screws. The three slots 90 are aligned along the radial axis to avoid any lateral unbalances. Each slot 90 is adapted to receive three removable counterweights 92.

In operation of the counterbalancing system as shown in FIG. 7, a user selects a particular cutting tool holder based on the size of the desired bore and the necessary rotational speed for the boring operation, which is based on, among other factors, the material to be bored. The cutting tool holder is centered on the rotational axis of the rotary boring head using traditional balancing methods. The user then adjusts the tool carrier radially to obtain the desired diameter for the bore. A chart, based on the length and weight of the cutting tool holder and the amount of radial adjustment, provides the user with the appropriate number of counterweights that must be removed to counteract the unbalance resulting from the radial adjustment. The counterweights must be removed in a manner that avoids any lateral unbalances. For example, the first counterweight is removed from the center slot in FIG. 7. When a second counterweight is to be removed, the first removed counterweight must be returned to the center and one counterweight is removed from each of the outside slots to maintain lateral balance. This process must be repeated up to the removal of all nine counterweights employed in the embodiment shown in FIG. 7.

While illustrative embodiments have been presented and described, it will be clear to those proficient in the art that various changes can be made therein without departing from the spirit and scope of the invention.

What is claimed is:

1. A rotary boring head comprising:
a rotating body;
a radially movable tool carrier within the rotating body designed to accommodate a tool holder;
a precision spindle connected to the radially movable tool carrier;
a spindle adapter connected to the rotating body;
one or more slots located on the rotating body aligned in the axis of radial motion of the tool carrier wherein the one or more slots are designed to accommodate a number of selectively removable counterweights.

2. The rotary boring head of claim 1 wherein the rotary boring head is manufactured to eliminate all lateral unbalances.

3. The rotary boring head of claim 1 wherein the counterweights constitute set screws.

4. The rotary boring head of claim 1 wherein the counterweights may be selectively added to or removed from the one or more slots to counteract unbalances resulting from radial adjustments of the tool carrier.

5. The rotary boring head of claim 4 wherein the one or more slots are located on the backside of the rotating body such that the counterweights are secured when the spindle adapter is located in a chuck or bit holder.

6. The rotary boring head of claim 5 wherein the counterweights are prevented from separating from the rotating body by centrifugal force.

7. The rotary boring head of claim 1 wherein the precision spindle is equipped with a micrometer dial to determine the relative radial adjustment of the tool carrier.

8. A cutting tool holder comprising:
a nose;
a shaft which is removably connected to the nose; and
a counterweight on the nose;
wherein said counterweight is designed to perfectly mass balance the cutting tool holder in all directions.

9. The cutting tool holder of claim 8 wherein a cutting insert may be removably attached to the nose of the cutting tool holder.

10. The cutting tool holder of claim 9 wherein the counterweight constitutes an additional mass on the rear portion of the nose opposite the cutting insert.

11. The cutting tool holder of claim 10 wherein the counterweight is machined onto the nose of the cutting tool holder.

12. The cutting tool holder of claim 10 wherein the counterweight is casted onto the nose of the cutting tool holder.

13. The cutting tool holder of claim 9 wherein the counterweight is formed using powder metal technology.

14. A diameter adjustment oriented balancing system comprising:
a rotary boring head with a rotating body which includes a radially movable tool carrier designed to accommodate a tool holder;
one or more slots located on the rotating body aligned in the axis of radial motion of the tool carrier wherein the one or more slots are designed to accommodate a number of selectively removable counterweights;
a number of selectively removable counterweights; and
a number of mass balanced tool cutting tool holders;
wherein said counterweights are selectively removable to accommodate for unbalances resulting from radial adjustment of the tool carrier and cutting tool holder.

15. The diameter adjustment oriented balancing system of claim 14 wherein counterweights are selectively added or removed based on the amount of radial adjustment, the diameter of the cutting tool holder and the mass of the cutting tool holder.

16. The diameter adjustment oriented balancing system of claim 15 further comprising:
a chart outlining the number of counterweights to be selectively added or removed based on the amount of radial adjustment, the diameter of the cutting tool holder and the weight of the cutting tool holder.

17. A method of balancing a small diameter rotary boring head comprising:
selecting a mass balanced cutting tool holder;
placing the cutting tool holder in a radially movable tool carrier in a rotating body which is part of the rotary boring head;
balancing the rotary boring head;
radially adjusting the tool carrier to achieve a specific boring diameter; and
selectively adding or removing counterweights to balance the rotary boring head.

18. The method of claim 17 wherein the counterweights are selectively added or removed based on the cutting tool holder selected and the amount of radial adjustment.

19. The method of claim 18 wherein the counterweights are selectively added or removed to one or more slots located on the rotating body aligned in the axis of radial motion of the tool carrier.

20. The method of claim 19 wherein one or more slots are located on the backside of the rotating body such that the counterweights are secured when the spindle adapter is located in a chuck or bit holder.
